(19) United States
(12) Patent Application Publication
(10) Pub. No.: US 2013/0264785 A1
(43) Pub. Date: Oct. 10, 2013

(54) Narrow articulated vehicle

(71) Applicant: James K. Bullis, Sunnyvale, CA (US)

(72) Inventor: James K. Bullis, Sunnyvale, CA (US)

(21) Appl. No.: 13/506,304

(22) Filed: Apr. 10, 2012

(51) Int. Cl. B62D 12/02; B60K 1/00; B60K 17/30; B62M 1/00

(52) U.S. Cl. 280/32.5; 280/442; 180/65.1; 180/252

(57) ABSTRACT

The vehicle is narrow such that it can pass through narrow space. The overall vehicle is approximately the same width as a seated worker. Stabilization is provided by wheel rigidity of a front and a rear wheel set that is configured to give a stable vehicle stance, even though it is exceptionally narrow. Energy efficient operation is achieved with wheels having approximately continuous ground contact from edge to edge of a wheel, thus maximizing ground contact area.

The narrow vehicle is an articulated configuration that enables agile turning. This articulated turning capability is especially suited for load carrying situations.

This patent document contains material that is subject to copyright protection. Facsimile reproduction is allowed of the patent document or the patent disclosure as it appears in the and Trademark Office patent file or records as allowed by US patent law, but otherwise all copyright rights are reserved.

### BACKGROUND OF THE INVENTION

1. Field of the Invention

This present invention relates to work vehicles.

2. Description of the Prior Art

Prior art by the present inventor, Ser. No. 13/199,968 Bullis 2011, and Bullis filed Mar. 14, 2012 relied on a cylindrically shaped rigid wheel concept that enables a stable narrow vehicle, when used in context of a low center of gravity configuration. The low center of gravity was a natural accomplishment where the original vehicle was specifically directed to enabling low to ground access to crops by farm workers. Implementing a low center of gravity was also eased by availability of electrical apparatus. The rigid wheel concept leads to particularly energy efficient operation due to it tendency to not sink much into the ground. This vehicle was designed to be light weight and low cost to manufacture. I achieved its functional objectives using a fairly long configuration suitable for large scale farming on large fields where rows are long. The turning mechanism was simple and adequate, but agility was limited and for some foreseeable loads it could have limitations.

Articulated work vehicles are long known. In the earth moving and road building worlds, drum rollers are used in articulated configurations and some models seek to limit the width, though this is not done even close to the extent of the Bullis, filed 2011, and Mar. 14, 2012 inventions. The drum roller apparatus generally involves a high seated operator and highly positioned engine and equipment. Ferrari Tractor Company is an Italian company that manufacturers narrow, articulated tractors that are said to be suitable for work in European vineyards, though their concept of narrow includes the standard four wheeled set of pneumatic tires, with differential apparatus between wheels. The Goldoni and Fort lines of tractors meets the vineyard row space standard that is traditionally defined as the width of the rear end of a mule. The Carrera line of tractors is also narrow, and includes many models, some including capability to run on separate crawler type tracks on each side of the vehicle.

An important factor in development of articulated work vehicles is the large weights generally involved in this typically large machinery. This weight prevents the unstable condition that could arise when center parts of the vehicle are shifted to the outside of a turn without balancing shift of weight in the end parts.

Garden tractors, including single axle types, meet the vineyard row space standard. Most single axle types do not enable a worker to ride. None have been found that involve a wide wheel, instead, these involve dual rubber pneumatic wheels on an axle, with the exception of very old versions that used steel wheels. Even these old tractors involved a steel wheel on each side.

References are specifically incorporated in the present application.

### SUMMARY OF THE INVENTION

The present invention relates particularly to the previous narrow vehicle invention of U.S. Ser. No. 13/199,968 Bullis 2011, and another by Bullis filed Mar. 14, 2012 which are incorporated here by reference.

The vehicle is narrow such that it can pass through narrow space. The overall vehicle is approximately the same width as a seated worker. Stabilization is provided by wheel rigidity of a front and a rear wheel set that is configured to give a stable vehicle stance, even though it is exceptionally narrow. Energy efficient operation is achieved by the use of the rigid wheel sets that provide approximately continuous ground contact from edge to edge of a wheel, thus maximizing ground contact area.

The narrow vehicle is enhanced with an articulated configuration that enables agile turning. This articulated turning capability is especially suited for load carrying situations.

This vehicle stands apart from the traditional work vehicles with its particularly narrow width. It is intended for use in every way now done with work vehicles and with every vehicle attachment known, though such would be adapted for narrow access situations.

### BRIEF DESCRIPTION OF THE DRAWINGS

FIG. 1 Narrow articulated vehicle in isometric view.

FIG. 2 Narrow articulated vehicle in side view.

FIG. 3 Narrow articulated vehicle in turning operation in plan view.

### DETAILED DESCRIPTION

Much of the detail of the vehicle is well known in the fields of tractor design and broader work vehicle design. Special features are emphasized in the following discussion. Construction details that are within the art are only suggested or left without detailing.

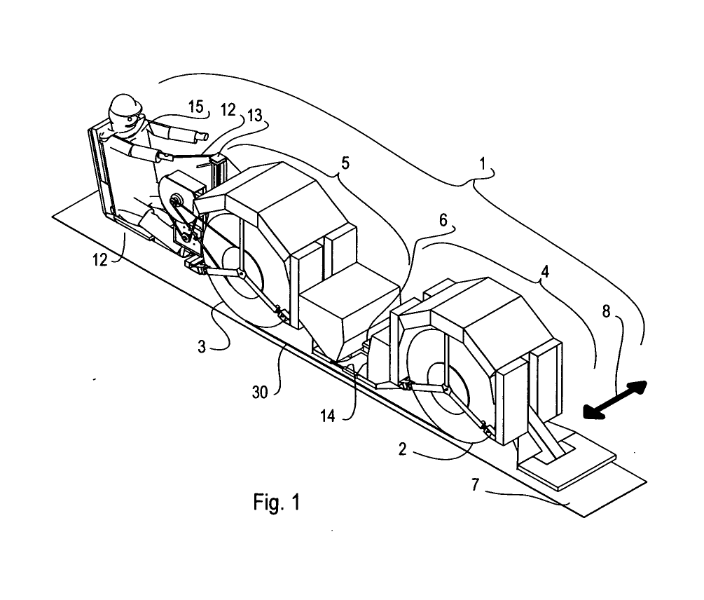

FIG. 1 shows an isometric view of the here invented vehicle 1 on a ground surface 7. The vehicle width indicated 8 enables passage through narrow spaces. Front rigid wheel 2 and rear rigid wheel 3 are attached to front frame 4 and rear frame 5 respectively. The joint 6 between the frames enables articulated turning action. The seated worker placeholder 15 is shown with a right arm controlling a steering tiller 12 that controls the hydraulic steering actuation apparatus 13 which is linked to hydraulic actuators. The right such actuator 14 is shown. The seating apparatus 12 enables a low seating position.

Rigidity of wheels is such that the outer edges of wheels define horizontal lines that are the axes of a roll-over situation, to either side as the case may be. Wheel base widths 60,61 are the lateral distances between these roll over axes. The rigidity also provides for continuous load bearing contact over the width of wheels.

Preferred wheels are hollow cylinders, like drums, with rolling surfaces made of material and shaped according to application. The previous invention, U.S. Ser. No. 13/199,968 Bullis 2011, disclosed slats that have a rubber surface being attached to the drum running surface to provide strength at the surface and a slightly soft ground contract surface. Presently, track pads from the heavy track vehicle industry are being utilized as the slats wheels 2,3; these having been acquired from McLaren Industries, as part Hybrid Rubber Shoes 350 MM. The fact of generally low center of gravity, low operating speed makes it possible that the wide and firm drum wheel system provides the needed stability. And of course, the large area footprint of such a wheel system 2 means the whole vehicle will operate much more efficiently than vehicles with wheels having a smaller footprint.

The described embodiment is an agricultural vehicle for work in narrow row spaces of planted fields. However, work vehicles in general can be implemented using the invented concept.

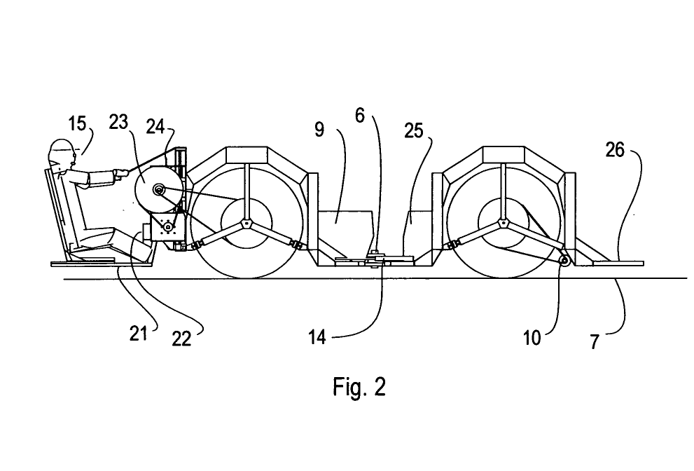

FIG. 2 is a side view that provides better visibility of the articulated joint 6. It also notes steering means apparatus included in auxiliary engine compartment 9. Though rear wheel electric drive is shown, a particular feature of articulated steering, where sharp turning is desired, is occasional need for two wheel drive as enabled by auxiliary activator 10 for this purpose.

Representative vehicle components include seat apparatus 12 that includes seat tongue and swing seat longitudinal bearing 22. A winch 24 enables elevating the seat apparatus 12. Gearing means 23 enables appropriate work vehicle speeds. Battery pack 25 enables electric operation, including a hybrid mode for sustained operation over lengthy periods without charging. A load platform 26 is shown attached to the front frame. Proper weight distribution involving frames and heavy items such as battery pack 25 and apparatus in engine compartment 9, together with load on load platform 26 and other attached weight enables stability to be maintained in carrying loads through turning actions.

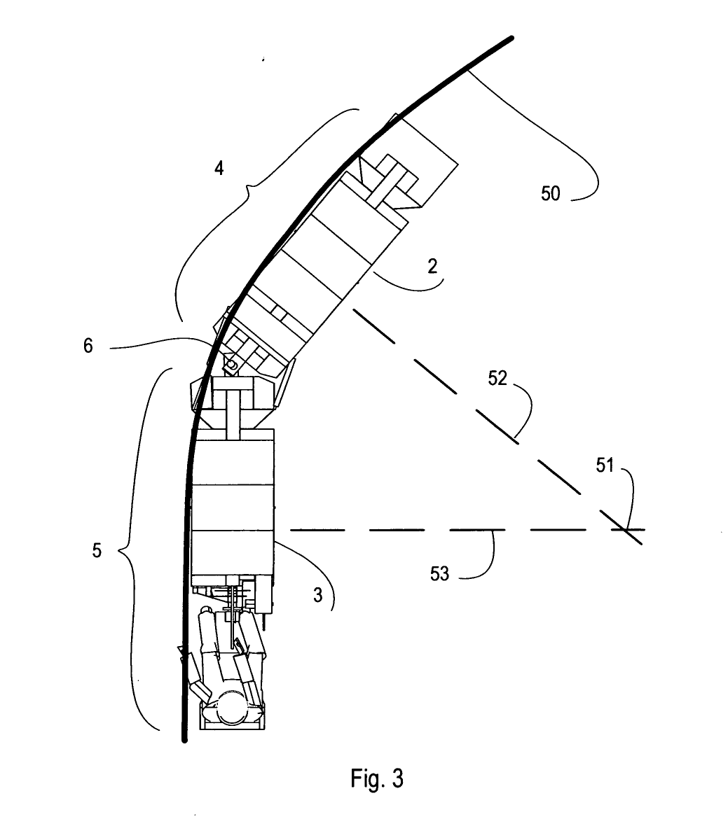

FIG. 3 is a plan view that illustrates turning action where front frame 4 is oriented relative to rear frame 5 to cause an ideal turning action, where the rear wheel 3 closely tracks the front wheel 2 along a path 50, particularly in the illustrated case where the joint 6 is equidistant to each respective wheel. Vehicle weight distribution is possible such that the turning action does not involve extreme lateral accelerations that are known in the more common, conventional wheel steering operations. Curvature of a circle path 50 which the vehicle can follow is a radius of that circle centered on a point 51 that is an intersection of axle lines 52,53.

The plan view of FIG. 3 makes evident the generally long vehicle compared to vehicle width.

The scope of the invention is to be defined by the appended claims.

I claim:

1. A narrow vehicle for operation on a surface, where said narrow vehicle includes two frames with at least one wide wheel apparatus attached to each frame, where said two frames are linked by a rotational joint,
where a wide wheel apparatus has a width approximately equal to width of its respective frame, where a said wide wheel apparatus is rigid such that it causes a stabilizing wheel base width that is approximately equal to width of its said respective frame, and where said wide wheel apparatus causes continuous load bearing contact with said surface from edge to edge of said wide wheel apparatus,
where said rotational joint enables a steering control means to cause pivoting action between said two frames that causes turning action along a surface path of radius less than an overall length of said vehicle,
where said narrow vehicle has a width that enables passage through a narrow space that is less than approximately forty eight inches in width.

2. A narrow vehicle according to claim 1 where said narrow space is less than thirty-six inches in width.

3. A narrow vehicle according to claim 1 where said narrow space is less than thirty inches in width.

4. A narrow vehicle according to claim 1 where said radius is less than a wheel base length from front-most wheel to rear-most wheel.

5. A narrow vehicle according to claim L that is a low center of gravity vehicle, where said low center of gravity in combination with said stabilizing wheel base enables stable operation at a speed of ten miles per hour on a path where said radius is equal to an overall length of said narrow vehicle.

6. A narrow vehicle according to claim 1 that is a low center of gravity vehicle with a wheel base length from a front-most point of wheel surface contact to a rear-most point of wheel surface contact, where said low center of gravity in combination with said stabilizing wheel base enables stable operation at a speed of ten miles per hour through a turning radius equal to said wheel base length.

7. A narrow vehicle according to claim 1 that is a light weight vehicle.

8. A narrow vehicle for multi-purpose work operations.

9. A narrow vehicle according to claim 1 that is equipped to carry a worker, where seating provisions enable said worker to ride low to said surface.

10. A narrow vehicle according to claim 1, where overall vehicle length is more than four times said stabilizing wheel base width.

11. A narrow vehicle according to claim 1, where said two frames are a front frame and a rear frame, and said rear frame follows said front frame in forward travel through said narrow space, where frames trace out respective spaces, and said spaces are approximately identical.

12. A narrow vehicle according to claim 1, where said pivoting action causes a centerline track of a rear wheel apparatus to follow a centerline track of a front wheel apparatus on said surface.

13. A narrow vehicle according to claim 1 equipped for load carrying operation, where a loaded weight distribution enables said narrow vehicle to maintain stability during travel along a curved surface track at a speed appropriate for agricultural field operation.

14. A narrow vehicle according to claim 1 that includes a seat apparatus that enables a worker to ride at heights above a ground surface that are adjustable.

15. A narrow vehicle according to claim 1 that includes capability to operate under electric power.

16. A narrow vehicle according to claim 1 that includes capability to operate under electric power, with auxiliary power capability from an engine.

17. A narrow vehicle according to claim 1 that includes a capability for multiple wheel drive.

18. A narrow vehicle according to claim 1 that includes a capability for multiple wheel drive, where one wheel is driven on an auxiliary basis to enable sharp turning operations.

19. A narrow vehicle according to claim 1, where said width is approximately that of a typical, fully grown, mule.

20. A narrow powered vehicle that enables an operator to ride there-on, where said narrow powered vehicle includes two frames with a wheel attached to each frame, where at least one said wheel is a rigid wheel apparatus that enables load bearing contact with a ground surface, where said contact is approximately continuous from edge to edge of said rigid wheel apparatus, where said two frames are linked by a rotational joint that enables a steering control means to cause pivoting action between said two frames that causes vehicle turning action along a ground path, where said vehicle has a width that enables passage through a narrow space of an approximate width of a typical, fully grown mule.

21. A narrow powered vehicle according to claim 20, where said rigid wheel apparatus operates on a single, crawler type track that extends laterally across a width of said vehicle, where turning action of said crawler type track is caused by said pivoting action.
